(19) United States
(12) Patent Application Publication
(10) Pub. No.: US 2004/0160136 A1
(43) Pub. Date: Aug. 19, 2004

(54) Spindle motor for hard disk drive

(75) Inventors: Jin-Gyoo Yoo, Kyungki-do (KR); Tae-Yeon Hwang, Kyungki-do (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Kyungki-do (KR)

(21) Appl. No.: 10/437,197

(22) Filed: May 14, 2003

(30) Foreign Application Priority Data
Feb. 18, 2003 (KR) 2003-10046

(51) Int. Cl. H02K 5/16

(52) U.S. Cl. 310/90

(57) ABSTRACT

A spindle motor for a hard disk drive includes a base on which a stator is installed, a sleeve fixedly installed on the base and having a hollow portion, a shaft rotatably installed in the hollow portion of the sleeve, and a hub fixed to an upper portion of the shaft and where a rotator corresponding to the stator is installed. A plurality of grooves to generate hydrodynamic pressure in a radial direction of the shaft are formed on an outer circumferential surface of the shaft in a herringbone shape, and one side of each groove is formed inclined from a lower surface portion of the groove.

### BACKGROUND OF THE INVENTION

This application claims the priority of Korean Patent Application No. 200310046 filed on Feb. 18, 2003 in the Korean Intellectual Property Office, the disclosure of which is incorporated herein in its entirety by reference.

1. Field of the Invention

The present invention relates to a spindle motor for a hard disk drive, and more particularly, to a spindle motor for a hard disk drive which can reduce a friction loss and minimize a change in the stiffness of a bearing according to the temperature.

2. Description of the Related Art

A spindle motor is widely used for a laser beam scanner motor for a laser printer, a motor for a hard disk drive, and a motor for an optical disk drive such as a CD (compact disc) or a DVD (digital versatile disc). Since the spindle motor used for a hard disk drive requires a high speed driving force, a hydrodynamic bearing exhibiting a low driving load is typically used.

FIG. 1 shows a spindle motor disclosed in U.S. Pat. No. 5,722,775 as an example of a spindle motor adopting a conventional hydrodynamic bearing.

Referring to FIG. 1, the spindle motor includes a base 11 and a sleeve 13. A shaft 15 is fixedly installed at a central portion of the base 11. A hollow portion into which the shaft 15 is inserted is formed in the sleeve 13. A coil 12 is provided at the base 11 to generate an electromagnetic force. A magnet 14 corresponding to the coil 12 is provided at the sleeve 13.

A bearing gap is formed between an outer circumferential surface of the shaft 14 and an inner circumferential surface of the sleeve 13. The bearing gap is filled with fluid such as lubricant or grease.

A plurality of grooves 20 are formed on the inner circumferential surface of the sleeve 13 in the form of a herringbone. The grooves 20 are formed in upper and lower portions on the inner circumferential surface to support the sleeve 13 in a radial direction of the shaft 15 by generating hydrodynamic pressure during the rotation of the sleeve 13. The section of each of the grooves 20 is rectangular as shown in FIG. 2.

Although not shown in the drawing, a plurality of grooves are also formed on the inner circumferential surface of the sleeve 13 facing upper and lower surfaces of a flange 25 formed at an upper end portion of the shaft 15. The grooves generate hydrodynamic pressure during the rotation of the sleeve 13 to support the sleeve 13 in an axial direction of the shaft 15.

When the spindle motor is applied to a 1 inch micro hard disk drive, the structure of the hard disk drive is complicated due to a sealing design to prevent leakage of fluid used for a hydrodynamic bearing. Also, a friction loss due to a viscous friction force used in the hydrodynamic bearing increases. Thus, the power consumption of the micro drive driven by a battery increases and life span thereof decreases.

Since a characteristic change due to heat of viscous fluid used in the hydrodynamic bearing is great, a change in the stiffness of the bearing of a spindle motor increases. Thus, a change in the characteristic due to heat of a micro drive system adopting the hydrodynamic bearing increases so that the system is unstable. Actually, in the room temperature, the temperature inside the hard disk drive rises up to 80° C. due to the heat generated during the operation of a hard disk drive. In particular, for a micro drive, since the amount of fluid used for the hydrodynamic bearing is very small, a possibility of lubricant fluid being reduced is high due to a vaporization phenomenon and the leakage of fluid caused by lowering of a viscous force of the fluid at a high temperature. When the phenomenon occurs, the lubricant fluid is not sufficiently supplied to a bearing portion or bubbles are generated at the bearing portion so that the characteristic of the hydrodynamic bearing is unstable. Therefore, a rotation characteristic of a spindle motor supported by the hydrodynamic bearing is unstable.

### SUMMARY OF THE INVENTION

To solve the above and/or other problems, the present invention provides a spindle motor for a hard disk drive which uses air as a lubricant to reduce a friction loss and minimize a change in the stiffness of a bearing according to a temperature and changes the shape of grooves to solve a problem that strength and load capacity required for the case in which air is used as a lubricant are not generated.

According to an aspect of the present invention, a spindle motor for a hard disk drive comprises a base on which a stator is installed, a sleeve fixedly installed on the base and having a hollow portion, a shaft rotatably installed in the hollow portion of the sleeve, and a hub fixed to an upper portion of the shaft and where a rotator corresponding to the stator is installed, wherein a plurality of grooves to generate hydrodynamic pressure in a radial direction of the shaft are formed on an outer circumferential surface of the shaft in a herringbone shape, and one side of each groove is formed inclined from a lower surface portion of the groove.

A bearing gap is formed between the outer circumferential surface of the shaft and an inner circumferential surface of the sleeve, and the bearing gap is filled with air.

The spindle motor further comprises a thrust flange extending from a lower end portion of the shaft, and a plurality of grooves to generate hydrodynamic pressure in an axial direction of the shaft are formed on each of upper and lower surfaces of the flange.

The shaft is made of ceramic such as alumina or zirconia. The sleeve is made of ceramic.

According to anther aspect of the present invention, a spindle motor for a hard disk drive comprises a base on which a stator is installed, a sleeve fixedly installed on the base and having a hollow portion, a shaft rotatably installed in the hollow portion of the sleeve, and a hub fixed to an upper portion of the shaft and where a rotator corresponding to the stator is installed, wherein a plurality of grooves to generate hydrodynamic pressure in a radial direction of the shaft are formed on an inner circumferential surface of the sleeve in a herringbone shape, and one side of each groove is formed inclined from a lower surface portion of the groove.

A bearing gap is formed between an outer circumferential surface of the shaft and the inner circumferential surface of the sleeve, and the bearing gap is filled with air.

The sleeve is made of ceramic such as alumina or zirconia. The shaft is made of ceramic.

### BRIEF DESCRIPTION OF THE DRAWINGS

The above features of the present invention will become more apparent by describing in detail preferred embodiments thereof with reference to the attached drawings in which:

FIG. 1 is a view illustrating the structure of a conventional spindle motor for a hard disk drive;

FIG. 2 is a view illustrating the profile of grooves formed on the inner circumferential surface of a sleeve shown in FIG. 1;

FIG. 3 is a view illustrating the structure of a spindle motor for a hard disk drive according to a preferred embodiment of the present invention;

FIG. 4 is a view illustrating a journal bearing portion shown in FIG. 3 by magnifying the same;

FIG. 5 is a sectional view taken along line V-V′ of FIG. 4;

FIG. 6 is an enlarged view of a portion A of FIG. 5;

FIG. 7 is a perspective view illustrating a thrust flange constituting a thrust bearing portion shown in FIG. 3;

FIG. 8 is a partially cut-away perspective view illustrating a sleeve applied to a spindle motor for a hard disk drive according to another preferred embodiment of the present invention;

FIG. 9 is a sectional view illustrating a journal bearing portion of the spindle motor for a hard disk drive of FIG. 8; and

FIG. 10 is an enlarged view illustrating a portion B of FIG. 9.

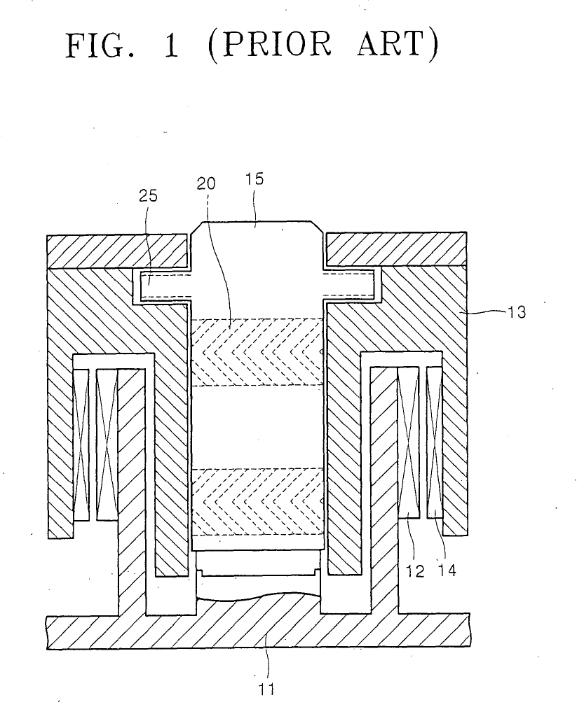

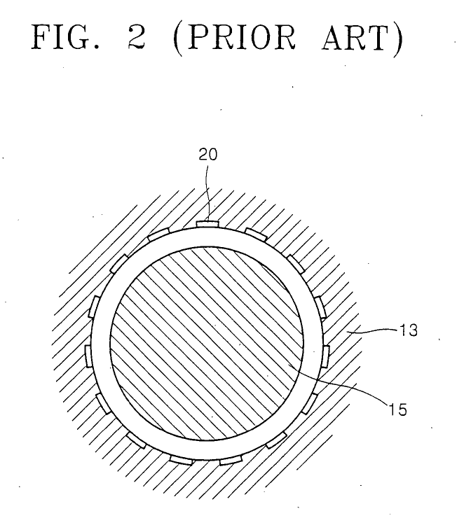

### DETAILED DESCRIPTION OF THE INVENTION

In the drawings, the same reference numerals indicate the same constituent elements and the size of each constituent elements may be exaggerated for the convenience of explanation.

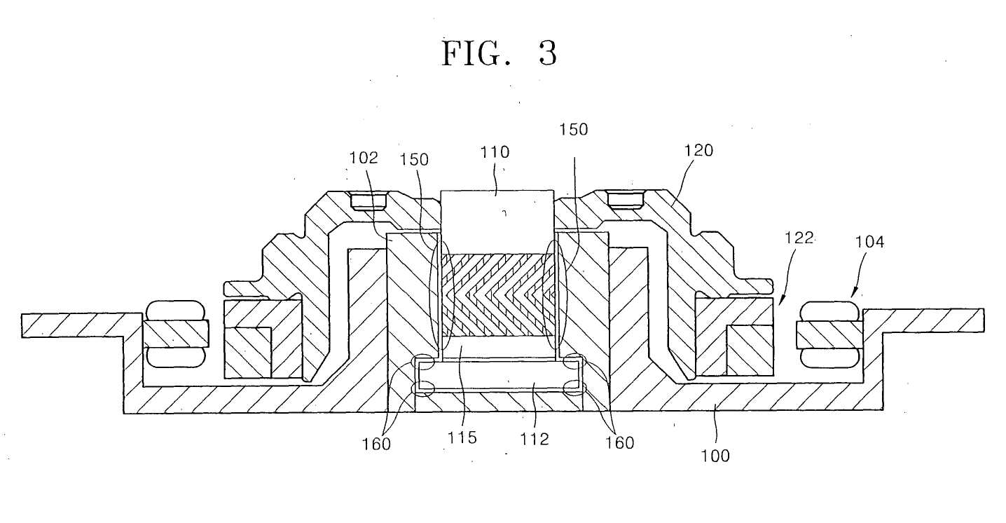

Referring to FIG. 3, a spindle motor according to a preferred embodiment of the present invention includes a base 100, a sleeve 102, a shaft 110, and a hub 120. A stator 104 including a core and a coil is provided at both sides of the base 100. The sleeve 102 is fixed on the base 100 and has a hollow portion at the central portion thereof to insert the shaft 110. The shaft 110 is rotatably installed in the hollow portion of the sleeve 102. The hub 120 for accommodating a disk is coupled to an upper portion of the shaft 110. A rotator 122 including a magnet and a yoke are provided at both sides of a lower portion of the hub 120 to correspond to the stator 104. The stator 104 and the rotator 122 generate an electromagnetic force by the interaction therebetween. Also, a thrust flange 112 for preventing the shaft 110 from escaping from the sleeve 102 is formed on the lower portion of the shaft 110.

The spindle motor for a hard disk drive includes a journal bearing part 150 supporting the shaft 110 in a radial direction and a thrust bearing part 160 supporting the shaft 110 in the axial direction.

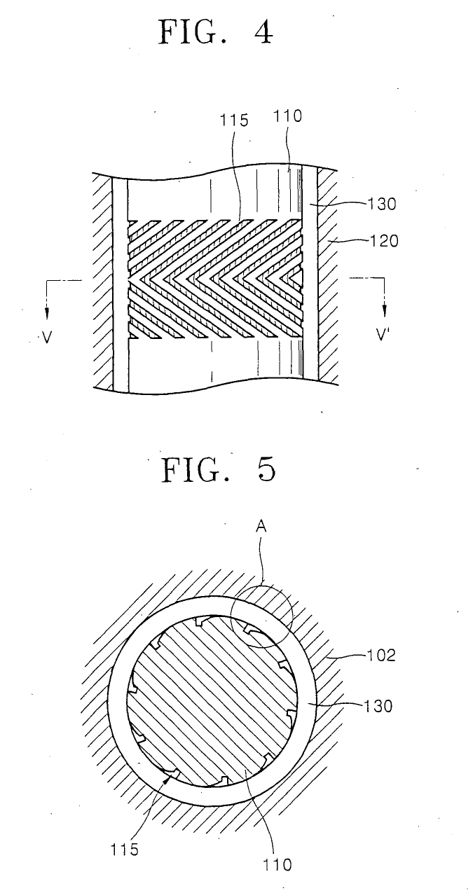

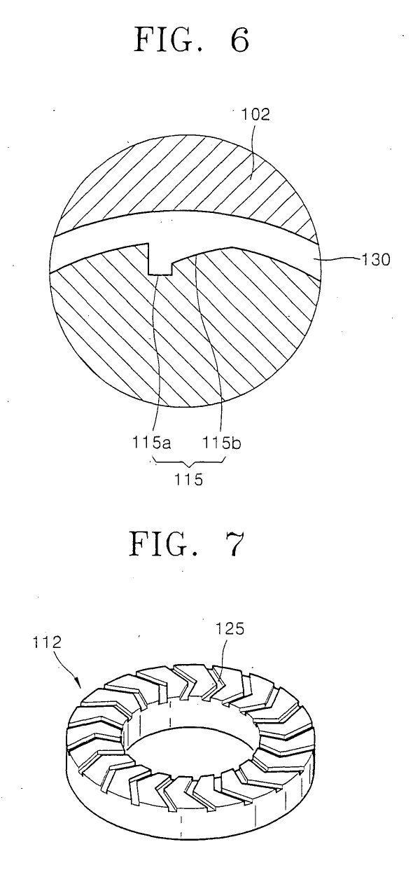

FIG. 4 shows the journal bearing part 150 shown in FIG. 3 by magnifying the same. FIG. 5 is a sectional view taken along line V-V′ of FIG. 4. FIG. 6 is an enlarged view of a portion A of FIG. 5.

Referring to FIGS. 4 and 5, a bearing gap to prevent friction between the shaft 110 and the sleeve 102 during rotation of the shaft 110 is formed between the outer circumferential surface of the shaft 110 and the inner circumferential surface of the sleeve 102. The bearing gap 130 is filled with lubricant fluid. Since the lubricant fluid separate the shaft 110 from the sleeve 102, the shaft 110 can rotate without contacting the sleeve 102. Thus, a non-repeatable runout (NRRO) having a bad influence on recording/reproduction of a hard disk is not generated.

Also, air can be used as the lubricant fluid in the present invention. When air having a low viscosity is used as the lubricant fluid, a frictional loss can be reduced and a change in the feature of a bearing due to a frictional heal can be minimized.

A plurality of grooves 115 for generating hydrodynamic pressure in a radial direction of the shaft 110 are formed on the outer circumferential surface of the shaft 110 in a herringbone shape. The grooves 115 having the herringbone shape can be formed at the upper and lower portions of the outer circumferential surface of the shaft 10. Also, each of the grooves 115, as shown in FIG. 6, has an inclined portion 115b which is inclined from a lower surface portion 115a of the groove.

When the grooves 115 including the inclined portion 115b are formed in the herringbone shape, a fluid pumping effect due to the herringbone shape and a wedge effect due to the inclined portion 115a can be obtained at the same time. Accordingly, a large load capacity and stiffness can be obtained and a rotational stability can also be secured.

FIG. 7 is a perspective view illustrating a thrust flange 112 constituting the thrust bearing portion 160 shown in FIG. 3. Referring to FIG. 7, a plurality of grooves 125 for generating hydrodynamic pressure in an axial direction of the shaft 110 are formed on an upper surface of the thrust flange 112 in a herringbone shape. The profile of each of the grooves 125 may be rectangular or inclined from a lower surface of each groove. In the meantime, although not shown in the drawing, the grooves 125 having the herringbone shape are also formed on a lower surface of the thrust flange 112.

The shaft 110 can be made of ceramic such as alumina or zirconia. Also, the sleeve 102 can be made of ceramic. This is to secure features such as anti-abrasion and anti-shock which are required for a spindle motor.

Next, a spindle motor for a hard disk drive according to another preferred embodiment of the present invention will now be described below. In the present preferred embodiment, the grooves having a herringbone shape is formed on the inner circumferential surface of the sleeve, not on the outer circumferential surface of the shaft, unlike the above-described preferred embodiment, while the other features are the same as those of the above preferred embodiment. Thus, only the different features of the present preferred embodiment will be described.

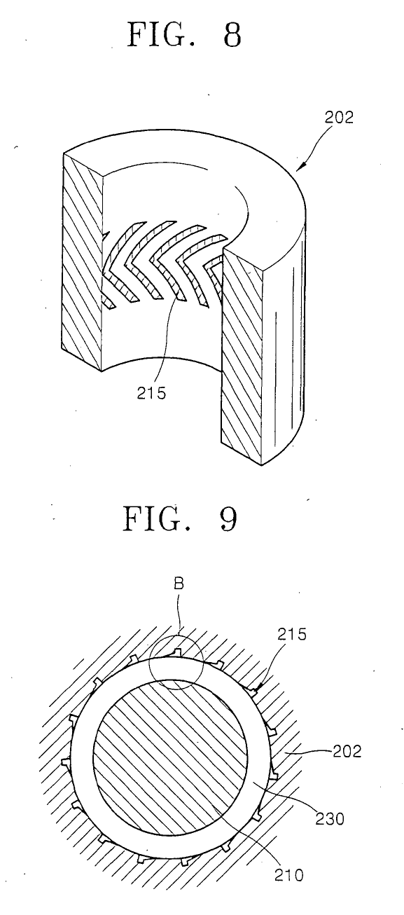

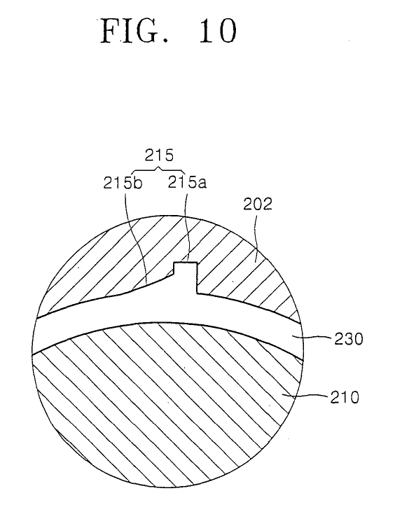

FIG. 8 shows the inside of a sleeve applied to a spindle motor for a hard disk drive according to another preferred embodiment of the present invention. FIG. 9 is a sectional view of a journal bearing portion of a spindle motor for a hard disk drive according to another preferred embodiment of the present invention. FIG. 10 is an enlarged view of a portion B of FIG. 9.

Referring to FIGS. 8 and 9, a plurality of grooves 215 for generating hydrodynamic pressure in a radial direction of a shaft 210 are formed on an inner circumferential surface of a sleeve 202 in a herringbone shape. Each of the grooves 215, as shown in FIG. 10, has an inclined portion 215b which is inclined from a lower surface portion 215a. The effects of the grooves 215 having the above shape is the same as those of the previous preferred embodiment.

A bearing gap 230 formed between the outer circumferential surface of the shaft 210 and the inner circumferential surface of the sleeve 202 is filled with lubricant fluid. Air can be used as the lubricant fluid.

Also, the sleeve 202 can be made of ceramic such as alumina and zirconia and the shaft 210 can be made of ceramic as well.

Table 1 and Table 2 show a change in stiffness of a hydrodynamic bearing used for the conventional spindle motor for a hard disk drive and a change in stiffness of an aerodynamic bearing used in the spindle motor for a hard disk drive according to the present invention, respectively, when the operational temperature increases from 20° C. to 60° C. Table 1 and Table 2 show the results of calculation of Reynolds equation, which is a lubrication equation, in a finite difference method (FDM) with respect to the respective bearings.

TABLE 1

| | |
|---|---|
| Temperature (° C.) | Rate of |

| | 20 | 60 | change (%) |
|---|---|---|---|
| Stiffness in radial | 1054.2 | 339.07 | −67.8 |
| direction (N/mm) | | | |
| Stiffness in axial | 35.548 | 21.346 | −40.0 |
| direction (N/mm) | | | |

TABLE 2

| | |
|---|---|
| Temperature | |
| (° C.) | Rate of |

| | 20 | 60 | change (%) |
|---|---|---|---|
| Stiffness in radial | 31.95 | 35.66 | +11.6 |
| direction (N/mm) | | | |
| Stiffness in axial | 47.60 | 52.07 | +9.40 |
| direction (N/mm) | | | |

Referring to Table 1, in the conventional spindle motor for a hard disk drive, the stiffness in the radial direction and the stiffness in the axial direction are reduced by 67.8% and 40.0%, respectively, In the spindle motor for a hard disk drive according to the present invention, according to Table 2, the stiffness in the radial direction increases by 11.6% as the temperature increases while the stiffness in the axial direction increases by 9.41%.

In the spindle motor for a hard disk drive according to the present invention, since a change in the stiffness of a bearing due to a change in temperature is small, a change in the natural frequency of a motor is small. Thus, the reliability of accuracy in rotation according to the operational temperature is higher than the conventional spindle motor for a hard disk drive.

Table 3 and Table 4 show a friction loss of the conventional spindle motor for a hard disk drive and a friction loss of the spindle motor for a hard disk drive according to the present invention, respectively, when the operational temperatures are 20° C. and 60° C. Table 3 and Table 4 show the results of calculation of Reynolds equation, which is a lubrication equation, in a finite difference method (FDM) with respect to the respective bearings.

TABLE 3

Temperature
(° C.)

| | 20 | 60 |
|---|---|---|
| Friction loss of journal | 17.5 | 6.01 |
| bearing (mW) | | |
| Friction loss of thrust | 11.3 | 3.88 |
| bearing (mW) | | |

TABLE 4

Temperature
(° C.)

| | 20 | 60 |
|---|---|---|
| Friction loss of journal | 0.0441 | 0.0487 |
| bearing (mW) | | |
| Friction loss of thrust | 0.0360 | 0.0392 |
| bearing (mW) | | |

Referring to FIGS. 3 and 4, it can be seen that a friction loss of the spindle motor for a hard disk drive according to the present invention is remarkably reduced compared to the conventional friction loss of the spindle motor for a hard disk drive. In detail, the friction loss of a journal bearing decreases from 0.252% at 20° C. to 0.810% at 60° C. and the friction loss of a thrust bearing decreases from 0.319% at 20° C. to 1.01% at 60° C.

In the spindle motor of a hard disk drive according to the present invention, since the frictional loss of a bearing is remarkably less than that of the conventional spindle motor for a hard disk drive using a hydrodynamic bearing, power consumption decreases very much.

While this invention has been particularly shown and described with reference to preferred embodiments thereof, it will be understood by those skilled in the art that various changes in form and details may be made therein without departing from the spirit and scope of the invention as defined by the appended claims.

As described above, the spindle motor for a hard disk drive according to the present invention has the following effects.

First, since air having a relatively low viscosity is used as lubricant fluid filling the bearing gap, a frictional loss can be reduced and a change in the feature of a bearing due to a frictional heat can be minimized.

Second, since the grooves including inclined portions are formed in a herringbone shape, an effect of fluid pumping due to the herringbone shape and an effect of wedge due to the inclined portion can be obtained at the same time. Accordingly, a large load capacity and stiffness can be obtained and a stability in rotation can be obtained as well.

Third, since a change in the stiffness of a bearing generated due to a change in temperature is small in the spindle motor for a hard disk drive according to the present invention, a change in the natural frequency of a motor according thereto is small. Thus, the spindle motor for a hard disk drive according to the present invention is more reliable in accuracy in rotation according to the operational temperature than the conventional spindle motor for a hard disk drive.

Fourth, since the friction loss of a bearing in the spindle motor for a hard disk drive according to the present invention is remarkably smaller than that in the conventional spindle motor for a hard disk drive using a hydrodynamic bearing, power consumption is remarkably reduced. Thus, the spindle motor for a hard disk drive according to the present invention is mainly used for mobile apparatuses, in particular, for a 1 inch micro-hard disk drive requiring a lower power consumption.

What is claimed is:

1. A spindle motor for a hard disk drive comprising:
a base on which a stator is installed;
a sleeve fixedly installed on the base and having a hollow portion;
a shaft rotatably installed in the hollow portion of the sleeve, and
a hub fixed to an upper portion of the shaft and where a rotator corresponding to the stator is installed,
wherein a plurality of grooves to generate hydrodynamic pressure in a radial direction of the shaft are formed on an outer circumferential surface of the shaft in a herringbone shape, and one side of each groove is formed inclined from a lower surface portion of the groove.

2. The spindle motor as claimed in claim 1, wherein a bearing gap is formed between the outer circumferential surface of the shaft and an inner circumferential surface of the sleeve, and the bearing gap is filled with air.

3. The spindle motor as claimed in claim 1, further comprising a thrust flange extending from a lower end portion of the shaft, and a plurality of grooves to generate hydrodynamic pressure in an axial direction of the shaft are formed on each of upper and lower surfaces of the flange.

4. The spindle motor as claimed in claim 2, further comprising a thrust flange extending from a lower end portion of the shaft, and a plurality of grooves to generate hydrodynamic pressure in an axial direction of the shaft are formed on each of upper and lower surfaces of the flange.

5. The spindle motor as claimed in claim 1, wherein the shaft is made of ceramic.

6. The spindle motor as claimed in claim 2, wherein the shaft is made of ceramic.

7. The spindle motor as claimed in claim 5, wherein the ceramic is alumina or zirconia.

8. The spindle motor as claimed in claim 6, wherein the ceramic is alumina or zirconia.

9. The spindle motor as claimed in claim 5, wherein the sleeve is made of ceramic.

10. The spindle motor as claimed in claim 6, wherein the sleeve is made of ceramic.

11. A spindle motor for a hard disk drive comprising:
a base on which a stator is installed;
a sleeve fixedly installed on the base and having a hollow portion;
a shaft rotatably installed in the hollow portion of the sleeve; and
a hub fixed to an upper portion of the shaft and where a rotator corresponding to the stator is installed,
wherein a plurality of grooves to generate hydrodynamic pressure in a radial direction of the shaft are formed on an inner circumferential surface of the sleeve in a herringbone shape, and one side of each groove is formed inclined from a lower surface portion of the groove.

12. The spindle motor as claimed in claim 11, wherein a bearing gap is formed between an outer circumferential surface of the shaft and the inner circumferential surface of the sleeve, and the bearing gap is filled with air.

13. The spindle motor as claimed in claim 11, wherein the sleeve is made of ceramic.

14. The spindle motor as claimed in claim 12, wherein the sleeve is made of ceramic.

15. The spindle motor as claimed in claim 13, wherein the ceramic is alumina or zirconia.

16. The spindle motor as claimed in claim 14, wherein the ceramic is alumina or zirconia.

17. The spindle motor as claimed in claim 13, wherein the shaft is made of ceramic.

18. The spindle motor as claimed in claim 14, wherein the shaft is made of ceramic.
